(19) United States
(12) Patent Application Publication
(10) Pub. No.: US 2006/0164088 A1
(43) Pub. Date: Jul. 27, 2006

(54) Nmr apparatus for concurrent analysis of multiple samples using a receiver coil array

(76) Inventor: Robert Carter Hawkes, Cambridge (GB)

Correspondence Address: STAAS & HALSEY LLP, SUITE 700, 1201 NEW YORK AVENUE, N.W., WASHINGTON, DC, 20005, US

(21) Appl. No.: 10/548,657

(22) PCT Filed: Mar. 25, 2004
(86) PCT No.: PCT/GB04/01292

§ 371 Date: Sep. 9, 2005

(30) Foreign Application Priority Data
Mar. 27, 2003 (GB) 0307116.4

(51) Int. Cl. G01V 3/00

(52) U.S. Cl. 324/321; 324/318

(57) ABSTRACT

Apparatus is provided for causing nuclear magnetic resonance in a plurality of samples. The apparatus comprises a magnetic system for generating a magnetic field including a working volume in which the magnetic field is substantially homogeneous. A sample holder is adapted to hold the plurality of samples within the working volume. A common transmitting means provides radio frequency signals simultaneously to each of the samples thereby causing nuclear magnetic resonance within them. A multiple receiver array detects the nuclear magnetic resonance signals using a plurality of receiving means in corresponding receiving circuits where each circuit has a different spatial sensitivity to each sample. A probe and sample holder according to the invention are also provided.

The present invention relates to nuclear magnetic resonance apparatus for use with a plurality of samples.

Nuclear magnetic resonance is now a well-established and valuable tool in the field of chemical analysis. However, the apparatus is typically very expensive since it combines the technologies of cryogenics, powerful magnets with high precision fields, and sensitive receiving devices. For this reason, such apparatus is typically only found in academic institutions and undertakings having a large research focus.

One particular problem with the nuclear magnetic resonance (NMR) technique is that the sample to be evaluated must be situated in an extremely well-controlled magnetic and temperature environment so as to allow the weak NMR signals to be accurately received. As a result, the time required to locate a sample in such an environment may be lengthy. In addition the NMR experiments themselves are also time consuming and it may take one or two days in some cases in order to perform an NMR experiment.

These limitations cause a strong desire to improve the throughput of NMR experiments. One field in which this is becoming particularly problematical is that of biotechnology where in many cases it is desirable to perform experiments upon numerous samples such as proteins. These NMR experiments provide vital information concerning the protein structures and dynamics (for example their folding behaviour).

One method of addressing the problem is to produce a multi-sample system in which a plurality of samples are positioned within the apparatus.

One such method is described in U.S. Pat. No. 6,456,072 in which four samples are placed within an NMR spectrometer. Each of the samples is provided with a dedicated combined transmit-receive coil. RF signals are transmitted and received for each of the samples in sequence by their respective coils. Each sample is resonated within the resonance relaxation periods of all the other samples. There are however some disadvantages in using such a system particularly for experiments where simultaneous measurements are desired, this being the case particularly for samples of similar materials. In this case each sample is required to be well isolated and shielded from all other samples and corresponding transmitting coils, in order that RF signals from one coil do not stimulate the sample related to another coil. The system described, also requires high-speed switching apparatus in order to stimulate each of the samples in turn.

An alternative system is described in US2002/0130661. Here two counterwound receiver coils within a receiver circuit are used to obtain signals from two corresponding samples. An electromagnetic shield is also used to isolate the samples from one another. However, the shield takes up space and compromises the efficient use of the homogeneous magnetic region of the magnet. This apparatus therefore does not lend itself to the use of large numbers of samples.

There is therefore a need for a more simplified apparatus, capable of handling a plurality of similar or dissimilar samples and which is not particularly limited by the sample number.

In accordance with the first aspect of the present invention, we provide apparatus for causing nuclear magnetic resonance in a plurality of samples, comprising:—

a magnet system for generating a magnetic field;

a sample holder adapted in use to hold the plurality of samples within a working volume in which the magnetic field is substantially homogeneous;

a common transmitting means for transmitting radio frequency signals simultaneously to each of the samples in the magnetic field so as to cause nuclear magnetic resonance within them; and,

a multiple receiver array comprising a plurality of receiving circuits, each comprising receiving means and each circuit having a different spatial sensitivity to each sample.

With the present invention, a common transmitting means is provided which is therefore capable of transmitting RF signals to each of the samples in the sample holder. This allows for true simultaneous resonance in the plurality of samples. In addition, a multiple receiver array comprising a plurality of receiving circuits is provided, each circuit having corresponding receiving means. The combination of the transmitting and receiving means provides the ability to carry out simultaneous NMR experiments in multiple samples of either similar or dissimilar nature. This is advantageous in that it allows for the throughput of NMR experiments to be greatly increased.

The multiple receiver array of the invention is therefore one comprising at least two receiving means in corresponding circuits, these circuits being in sufficient proximity such that they interact by electromagnetic coupling. Preferably the receiving means are arranged to interact so as to reduce, and more preferably to cancel their mutual inductance.

The spatial sensitivity requirement is that each receiver must have a different sensitivity at each sample. Thus considering any one receiver, each sample will be at a different position in the field of view of that receiver and further, the sensitivity of that receiver must be different at each sample.

The use of a multiple receiver array is particularly beneficial since it allows for efficient use of the homogenous working volume.

In general, a processor is also provided in order to monitor the signals generated within the receiving circuits as a result of the receipt of RF signals by the receiving means. Such a processor may also control the common transmitting means and other aspects of the apparatus such as the magnet system. Preferably, the processor is adapted to monitor signals from a plurality of the samples simultaneously and to process the signals so as to distinguish the signals from the respective samples.

This allows for true multiple sample NMR to be performed in that the samples each receive common transmitted RF signals and also can be arranged in a common magnetic and temperature environment such that the received signals are truly representative of simultaneous multiple NMR experiments. This in turn leads to a reduction of experimental errors.

The magnet system generates a magnetic field comprising a working volume in which the field is substantially homogenous such that it enables NMR experiments to be performed.

The magnet system is also preferably arranged in use to generate a magnetic field having a field gradient. In this case, the plurality of samples are preferably positioned within the magnetic field such that they each experience a similar magnetic field gradient. This may be achieved by engineering the working volume of the magnetic field such that each of the plurality of samples is positioned within the uniform field of the working volume. When the field gradient is applied, each sample typically experiences a different net field, although with a similar gradient. The gradient may be applied in one or more dimensions. Preferably, the field gradient is also pulsed for example as part of a pulse sequence which is advantageous particularly for de-phasing the signal of water from samples held in aqueous solution.

Other coils may be provided as part of the magnet system including gradient coils and shims, as is known in the art.

The common transmitting means preferably comprises one or more transmitting coils and the receiving means likewise may also comprise coils. Saddle coils may be used as the transmitting and/or receiving coils. Such saddle coils are typically arranged as a “pair” placed upon either side of the sample holder in the form of a tube, the pair forming part of the same circuit.

In order to address the problems caused by mutual inductance in such receivers, it is advantageous to partially overlap the pairs of saddle coils. Such an overlap is preferably along a particular dimension wherein the relative spacing of the coils is arranged in relation to the samples within the holder such that each sample is positioned between a pair of saddle coils and is aligned substantially at the centre of the saddle coil pair with respect to the said dimension. The samples in this case are typically equally spaced along the dimension, preferably upon a common axis. Such coils may be arranged with a sample holder in which the samples are positioned parallel to the B₀ field as this aids in shimming.

The plurality of receiving means may alternatively be positioned azimuthally about a respective common axis. Typically the samples in this case are also positioned azimuthally about a respective common axis. For example, for a particular number of samples (and receivers) N, the samples and receiving means are generally each positioned about their respective axes, with an angular spacing of 360/N degrees. The common axes of the receiving means and the sample containers are preferably substantially the same axis, although the respective symmetry of the receivers and samples may be broken with a slight relative angular rotation of their axes of symmetry about the common axis, so as to meet the spatial sensitivity requirement. Alternatively the samples and/or receiving means may be distributed in an asymmetrical manner.

Preferably for azimuthally distributed samples and receivers, the corresponding receiving means comprise at least one transverse electrometric resonator such as a microstrip antenna. Preferably each of the receivers comprise such antennae.

In accordance with a second aspect of the present invention, we provide a probe for use with the apparatus according to the first aspect, in which nuclear magnetic resonance is generated in a plurality of samples, wherein the nuclear magnetic resonance apparatus comprises:—

a magnet system for generating a magnetic field;

a sample holder adapted in use to hold a plurality of samples within a working volume in which the magnetic field is substantially homogeneous;

a transmitting means for transmitting radio frequency signals to the samples in the magnetic field so as to cause nuclear magnetic resonance within them; and,

a multiple receiver array comprising a plurality of receiving circuits, each comprising receiving means and each circuit having a different spatial sensitivity to each sample, and wherein the multiple receiver array is mounted to the probe.

The multiple receiver array comprising receiving means in this case is arranged upon a probe that is typically removably insertable into the nuclear magnetic resonance apparatus. Such a probe may also comprise other coils for stimulating other NMR resonances, for example carbon and nitrogen, a “lock” coil for deuterium pulsing and additional shimming coils if required.

The receiver arrays as described above in connection with the first aspect of the invention may therefore take a similar form when mounted to the probe in connection with the second aspect of the invention.

Further, any probe according to the second aspect of the invention may be adapted to be cooled in use to cryogenic temperatures so as to improve the performance of the apparatus.

In accordance with a third aspect of the present invention, we also provide a sample holder for use with apparatus according to the first and/or second aspects in which nuclear magnetic resonance is generated by a plurality of samples, wherein the nuclear magnetic resonance apparatus comprises:—

a magnet system for generating a magnetic field;

a transmitting means for transmitting radio frequency signals to the samples held in the magnetic field so as to cause nuclear magnetic resonance within them; and,

a multiple receiver array comprising a plurality of receiving circuits, each comprising receiving means and each circuit having a different spatial sensitivity to each sample; and wherein the sample holder is adapted in use to hold the plurality of samples within a working volume in which the magnetic field is substantially homogenous.

The sample holder is typically removably insertable into the apparatus for use. In general, the samples in such a holder are spaced apart in accordance with the arrangement of the receiving means of the receiving circuits of the first or second aspects. Further advantage is provided in that the sample holder is preferably adapted such that each sample is separated by susceptibility matched material. Susceptibility matched plugs may be used for this purpose when in a stacked arrangement.

Depending upon the type of sample material to be measured, the sample holder may be further adapted such that each sample is composed of molecules of interest in solution. This liquid may be an aqueous solution containing the sample material and preferably the magnetic susceptibility of the plugs is then matched to that of the solution.

The use of samples in solution is advantageous for experiments involving biochemical samples such as proteins, particularly in that the quantity of liquid in such cases may be small. For structure determination at 600 MHz the protein sample may be dissolved in less than about 0.5 millilitres (such as 0.25 to 0.5) of water containing 5% D₂O (for “locking”). A typical solution concentration is 1 millimol, so for 0.5 millilitres of solution, with a protein molecular weight of 10 kDa, about 5 milligrammes of protein is needed. In some other experiments much smaller volumes can be used, for example about 1 nanolitre to 10 microlitres.

Although the number of samples is not particularly limited, some limitation is caused by both the size of the sample and the magnet system used. Typically 4 to 8 samples may be used. For small biological samples in micro or nanolitre quantities of solution, a large number of samples may be placed within the uniform field of a single working volume.

Various designs of sample holder are contemplated within the present invention. The sample holder may comprise a number of removably stackable ampoules, each ampoule having a lid of susceptibility matched material and being formed as a container to retain an NMR sample in solution; together with a tube within which the ampoules are stacked when in use. The lids preferably comprise injection ports so as to allow NMR samples in solution to be added or removed from the containers.

In apparatus where the receiving means are arranged azimuthally about an axis, the sample holder preferably comprises a tube having an axis; and a number of sample containers azimuthally distributed about that axis. The azimuthal distribution of the tubes is dependent upon the number of containers (each of which is also preferably a tube) and their size. Different respective radial positions of such tubes are also contemplated, to effect the spatial sensitivity requirement.

Some examples of nuclear magnetic resonance apparatus according to the present invention will now be described in association with the accompanying drawings, in which:—

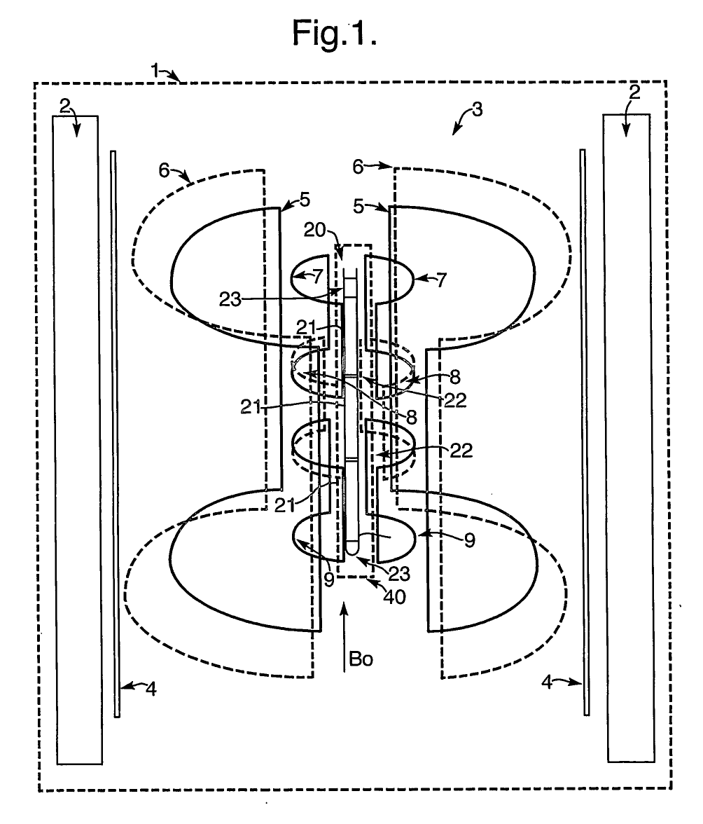

FIG. 1 is a schematic representation of a nuclear magnetic resonance apparatus according to a first example;

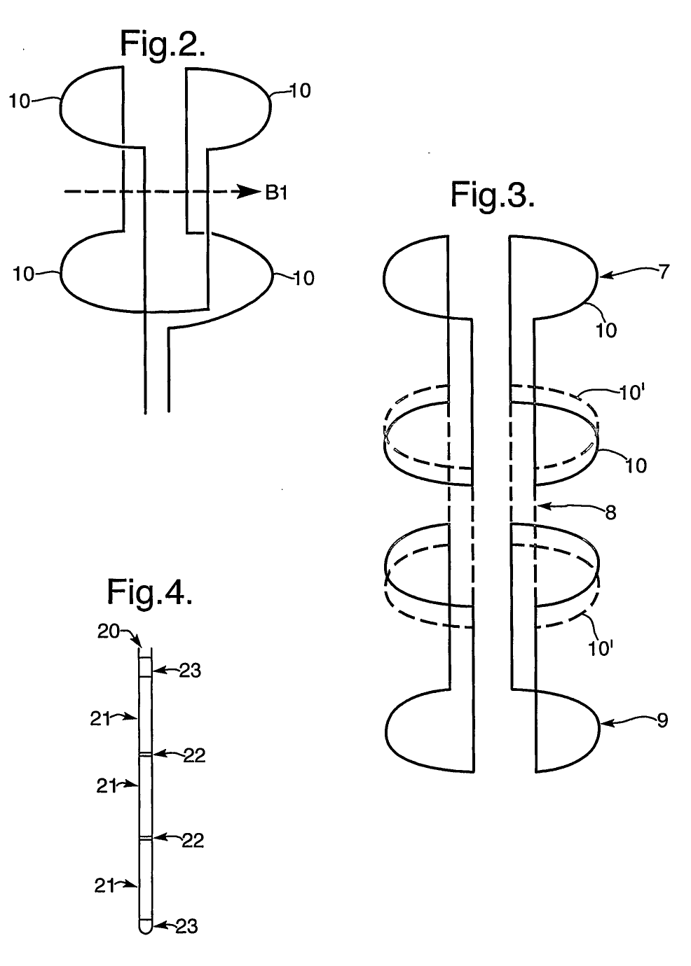

FIG. 2 shows a saddle coil pair;

FIG. 3 shows the arrangement of three partially overlapping receiver saddle coils; according to the first example;

FIG. 4 shows an example of a sample holder containing three samples;

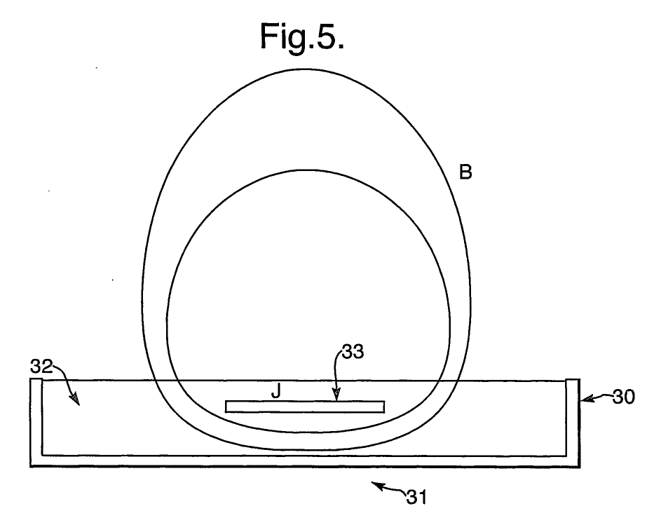

FIG. 5 shows a microstrip linear antenna;

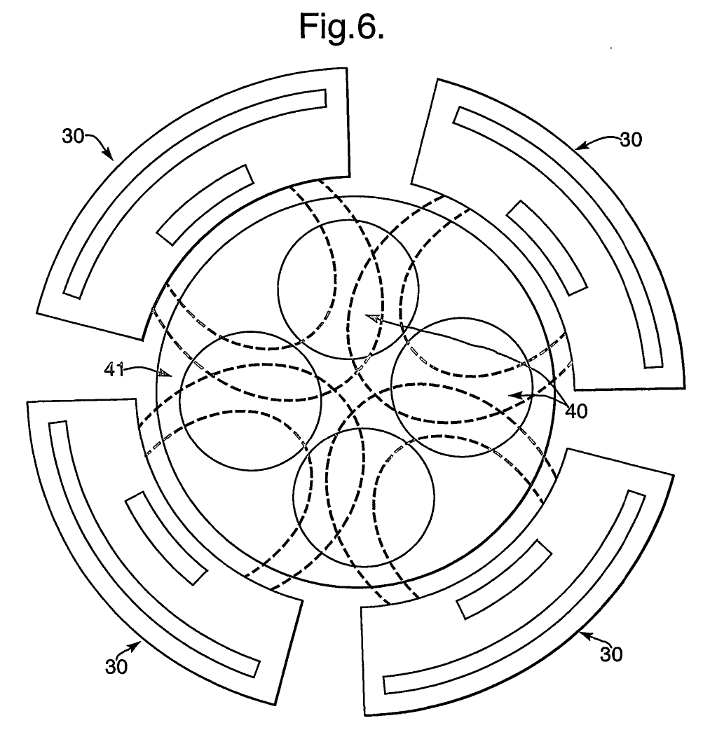

FIG. 6 shows the use of linear antennae according to a second example; and

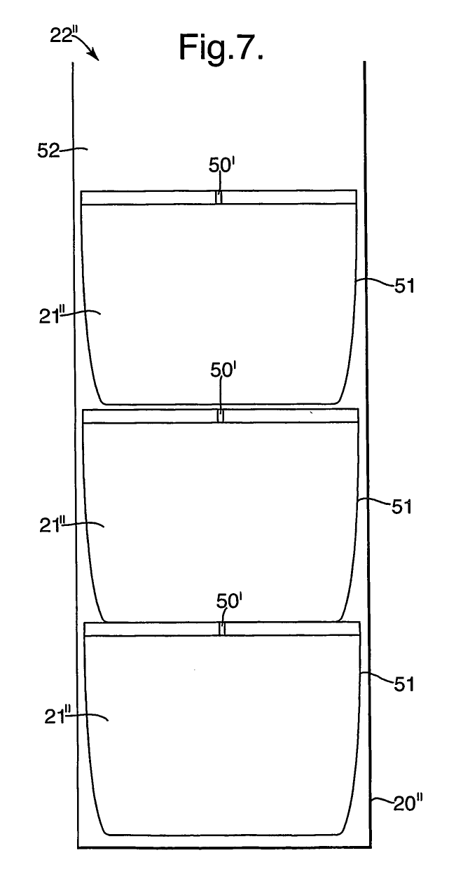

FIG. 7 shows a third example sample holder with ampoules.

FIG. 1 shows a schematic diagram of a first example of nuclear magnetic resonance (NMR) apparatus generally indicated at 1. This has a main solenoid magnet 2 belonging to the apparatus magnet system and which generates a B₀ field in the direction indicated. The main magnet 2 also defines an internal bore 3. Additional optional field gradient coils 4 are also indicated. It will be appreciated that the apparatus shown in FIG. 1 is typically located within a cryostat in order to produce a suitable low temperature environment for the coils to be superconducting.

Within the bore 3, which is at room temperature, are positioned a number of coils. Transmitting means in the form of two transmitter coil pairs 5 and 6 are provided, each in the form of saddle coils. A saddle coil takes the approximate form of a rectangle, two opposing sides of which are distorted in an arc as if each were tracing parallel lines on a cylindrical surface. A “pair” of coils is provided in each case on opposing sides of the centre of the bore 3. The transmitter coil pair 5 is arranged in use to transmit on the proton frequency whereas the coil pair 6 is double-tuned so as to transmit upon each of the carbon and nitrogen frequencies. It can be seen in FIG. 1 that the proton frequency transmitter coil pair 5 is arranged in closer proximity to the centre of the bore and partially encloses a cylindrical volume of smaller radius than the coil 6.

For transmitting purposes, larger diameter coils provide more uniform RF fields but also consume more power. The arrangement shown in FIG. 1, having a separate carbon/nitrogen double-tuned transmit coil, a separate proton transmit coil and a separate multiple proton receiver arrangement is only one of a number of possible arrangements according to the invention.

Although the saddle coils themselves are described as forming “pairs”, and they are shown as pairs in FIG. 1, in reality, each pair is wired in series forming a single coil circuit. This is shown more clearly in FIG. 2. FIG. 2 also schematically represents the RF field direction B₁, substantially perpendicular to the axis defined by the direction B₀.

Returning to FIG. 1, in a similar way, a number of receiver coil pairs 7, 8, 9 (receiving means) are aligned along a common axis and lie concentric within the bore 3 with the transmitter coil pairs 5, 6. These form a multiple receiver array. Again the coils within each pair are connected in series as a single coil. Receiver coils should be placed in close proximity to the samples as this improves the filling factor (the ratio of the coil size to sample size) and enhances signal reception.

As can be seen in FIG. 1, the receiver coil pairs 7, 8, 9 are arranged along this axis such that they partially overlap in the axial direction. The curved sections of these coils (shown more clearly at 10 in FIG. 2), are arranged adjacent one another with an overlap between adjacent coils. The overlap is adjusted so as to cancel the mutual inductance between adjacent coils. This is dependent upon the precise geometries and positioning of the coils chosen, which is a feature of the multiple receiver array design. The adjacent coils are positioned such that the net flux from one coil passing through the other is zero.

The arrangement of the three pairs of saddle receiver coils is shown in more detail in FIG. 3. The overlap of the lower curved sections 10 of the upper coil 7 is shown with respect to the corresponding upper curved sections 10′ of the intermediate coil 8.

With the arrangements shown in FIGS. 1 and 3, three receiver coils are positioned effectively in a stack, one above the other within the bore 3.

The partial overlap arrangement of the coils in this way provides great advantage in that it reduces the problems caused by mutual inductance between the coils and therefore allows signals to be received and distinguished from multiple samples in relative close proximity.

Although saddle coils are described according to the present example it will be appreciated that other types of coils such as “birdcage” and TEM “microstrip” coils may be used to implement the invention, an example of the latter being described later.

Referring once more to FIG. 1, a sample holder 20 is shown in a working position for NMR experiments, namely being positioned along the central axis of the various concentric transmitting and receiving coils and the bore 3. The sample holder 20 is in the form of an elongated tube defining an axis which is positioned along the axis of the coils. The sample holder contains three samples indicated at 21, positioned equally spaced along the length of the sample holder. These are physically separated by separator plugs 22, which are available commercially. The plugs effectively extend the air-to-sample and glass-to-sample interfaces away from the measurement region and thus reduce B₀ distortions. Also shown at 23 are plugs at the bottom and top of sample holder 20, these being also designed to reduce B₀ distortions.

The samples from which NMR signals are desired in the present example comprise particular proteins which are suspended in a solution. Each sample 21 within the sample holder 20 therefore comprises a solution containing the protein in question. The separator plugs 22 define the separation of the solutions in which the samples are contained and provide physical containment of the liquid at the desired location along the sample holder 20. The volume of fluid in each case is typically a few microlitres in this example.

The magnetic susceptibility of each of the separator plugs in the present case is therefore matched with that of the solution in which the samples are contained. This allows the sample holder to be shimmed when the sample holder is correctly located within the coils. It is advantageous to separate the samples along a common axis parallel with the B₀ direction since this also aids the shimming. As a result the sample holder is also elongated in this direction to assist shimming.

Typically, the bore within known nuclear magnetic resonance apparatus is of a rather limited diameter and the working volume in which the homogeneous magnetic field is generated is also narrow. The working volume is shown schematically in FIG. 1 at 40. Therefore, it is particularly advantageous to align the samples along the common axis.

FIG. 4 shows the sample holder 20 along with the samples 21 positioned along its length, including separator plugs 22.

FIG. 1 shows the working position of the sample holder 20 as inserted within the bore 3. It can be seen that the spacing between the samples 21 is equivalent to that of the receiver coil pair 7, 8, 9 such that a sample is positioned at substantially the geometrical centre of a corresponding receiver coil pair.

The main magnet 2, the field gradient coils 4 and any additional magnets for shimming purposes are arranged to provide a working volume which is sufficiently large enough to contain each of the samples at once. It is advantageous to use very small volumes of liquids containing the samples since this allows the working volume to be relatively small which in turn is easier to achieve technologically.

In order to operate the various receiver coils 7, 8, 9 of the array, the transmitter coils 5, 6 and indeed possibly the remainder of the nuclear magnetic resonance apparatus including the magnet system, a processor 30 is provided as schematically indicated in FIG. 1.

As is known in NMR apparatus, various coils are typically attached to a probe assembly which is removably insertable into the apparatus. Although not shown in the figures, the transmit coils and the multiple receiver array are attached to an insertable probe in the present example. This probe also contains coils so as to provide a field lock facility. Alternatively one of the other coils could be tuned to the deuterium frequency to provide this facility.

Once the sample holder 20 is loaded into the bore 3 to the position indicated in FIG. 1, the magnet system is then shimmed in order to take account of the distortions caused by the presence of the sample holder 20. Nuclear magnetic resonance experiments may then be performed under the control of a processor 30. Typically, these involve the transmission of signals on the proton frequency (using transmitter coils 5) and/or the carbon and nitrogen frequencies (using transmitter coils 6).

The signals received from the various coils of the multiple receiver array are processed by the processor 30. In practice the individual signals from each coil are contaminated with signals from more than one sample. These signals can be distinguished using the spatial response function of each coil, as each signal from a coil represents a linear combination of signals received from the various excited samples. The signals are also weighted by the receiving coil sensitivities. The distinguished individual signals for each sample are obtained using the information described above, by performing a matrix inversion. This allows the signals to be deconvoluted in a process analogous to the SMASH/SENSE type techniques now used in some medical MRI procedures. See simultaneous acquisition of spatial harmonics (SMASH): fast imaging with radiofrequency coil arrays. Magn. Reson. Med. 1997; 38:591-603 Sodickson D K, et al. and SENSE: Sensitivity Encoding for Fast MRI Magnetic Resonance in Medicine 42:952-962 (1999) Klaas P. Pruessmann, et al.

The example described above uses a multiple receiver array formed from axially arranged and partially overlapping saddle coils. Recent developments in the field of medical MRI have produced new types of receiver. We have realized that these may be adapted for use in the receiver arrays of the present NMR application.

One particularly beneficial “coil” design for use in the receiver array of the present application is the Transverse Electrometric Resonator (TEM).

One such design of TEM is the “planar strip array” (PSA) as described by Lee et al in Magnetic Resonance in Medicine 45:673-683 (2001). An alternative TEM receiver is the “Microstrip RF Surface Coil” described in Zhang et al, Magnetic Resonance in Medicine 46:443-450 (2001). An example of the use of TEMs is shown in FIG. 5.

In FIG. 5, the TEM antenna 30 is elongate in a direction normal to the plane of the figure. It comprises a conducting ground plate 31 (which is electrically grounded when in use), and upon which is mounted a dielectric material 32. As shown in FIG. 5, the ends of the ground plate 31 may be formed at a right angle so as to produce sides enclosing the dielectric. An elongate conducting strip 33 is located on or within the dielectric 32. As indicated, J is the current in a direction normal to the plane of the figure induced in the strip 33 by transverse magnetization.

A second example of the receiver array and multiple sample arrangement is shown in FIG. 6 which is a schematic view along the main field direction. The remainder of the apparatus is similar to that of FIG. 1, for example including the gradient coils. In this case four samples are held in corresponding sample containers 40 which are positioned azimuthally, rather than axially as in the previous example. The sample containers 40 are ampoules or tubes. They are preferably elongate in the axial direction so as to increase the amount of sample material from which signals are obtained, thereby improving the signal to noise ratio. The sample containers 40 are located within a larger tube 41, these together forming a sample holder. The tube 41 is arranged in use to contain similar solvent (for example chloroform or DMSO) to that within the sample containers 40.

Four TEM antennae 30 comprising a coupled array are equally spaced around the periphery of the tube 41. As can be seen, each of the antennae are modified to adopt a curved shape, which is conformal with the bore of the magnet. Each antenna is also elongate in a direction normal to FIG. 6. Dotted lines indicate RF field intensity lines according to each antenna and these can be seen to overlap.

It will be noted from FIG. 6 that the axes of symmetry defining the relative arrangement of the sample holders 40, do not coincide with those defining the antennae 30 arrangement. This is deliberate and ensures that each individual antenna “sees” a different response from the four samples, that is, the antennae each have a different spatial sensitivity with respect to the samples. The strip lengths of the antennae are adjusted to remove coupling between strips. The strips are tuned and matched to the frequency appropriate for NMR in the main magnetic field.

It will be understood that the second example provides advantages in terms of ease of shimming and sample handling, despite the fact that, whilst within the working region, the samples are not located on the central axis of the magnet. As in the previous example, separate coils can be used as the common transmitting means. Alternatively the antennae 30 can also be used for this purpose.

Aside from the sample holder described with reference to FIG. 4, it will be understood that other sample holder arrangements can be used, particularly in conjunction with appropriate dedicated multiple receiver array arrangements.

An alternative vertical stack sample holder is shown in FIG. 7. Here a number of ampoules 51 are prepared and filled off line, each containing an NMR sample 21″ of interest in a solvent. Each ampoule is capped with a susceptibility matched lid 22″, each lid having an injection port 50′. Prior to use, the filled ampoules are stacked within a glass tube 52 forming the main part of the holder 20″. Any air between the ampoules and the tube 52 is removed by filling the tube 52 with a liquid such as the solvent used in the ampoules.

It will be understood that the handling of samples in such sample holders requires special care. This is because in many applications there can be no cross contamination of samples whatsoever. An example is in the field of forensics where it must be ensured that the samples are entirely and reliably separate. The example above using ampoules is particularly advantageous in this regard since the individual sample ampoules may be prepared at separate locations, or at separate times to eliminate cross-contamination risks.

The apparatus described can be formed by the modification of existing NMR magnet systems. Alternatively dedicated NMR systems can be produced with magnets providing appropriate working regions, along with shimming and gradient coils.

In the case of obtaining NMR data for biochemical materials such as proteins, it is advantageous to use gradient coil pulses as part of “inverse” experiments since these allow the removal of the water signal and therefore allow the experiment to be performed more quickly. The use of gradient pulses de-phases the water signal whereas that of the protein does not de-phase due to the physical diffusion rates being so dissimilar between the two entities. The apparatus according to either example therefore preferably further comprises common means to apply such gradients to all samples using for example, magnetic gradient coils. As mentioned earlier other RF coils such as common lock coils, nitrogen and carbon coils may also be provided, depending upon the experiments involved.

The arrangement of multiple samples and RF coils making up the probe is ideally suited to HSQC and HMQC type experiments. These give an increase in sensitivity by detecting the most sensitive nuclei, protons, instead of the lower-gamma nuclei of carbon and nitrogen (the sensitivity of a nucleus is proportional to the cube of its frequency). This requires the use of 15N and/or 13C heteronuclear labels and necessitates the implementation of “polarization transfer” experiments, which transfer magnetization (via heteronuclear coupling) from the sensitive 1H nucleus to the insensitive heteronuclei (15N, 13C), and finally back to the 1H, where it is detected.

Pulse field gradients are used for coherence selection and suppression of solvent signals and artefacts, especially those due to water. The pulse sequences are composed of a large number of RF pulses that can be applied at several different frequencies in order to excite multiple resonances. High RF homogeneity of the transmission coils of the probe on all frequency channels is provided.

Each sample is placed in the same homogeneous field and the object of the susceptibility matching is to enable the “whole” array of samples to be shimmed to 10⁻⁸ to 10⁻⁹ ppm. When the gradient field is applied, as a pulse, this is a variation in the strength of the main field. This variation is usually in the main field direction i.e. dB₀/dz if only a single axis gradient is used and is normally linear.

Referring to FIG. 1, the processor 30 carries out the pulse sequences by the use of the field gradient coils 4 and the transmitting coils 5 and 6. This allows for measurements to be taken simultaneously upon each of the samples using the receiver coils 7, 8, 9 of the multiple receiver array. This is particularly preferable where measurements are desired from multiple samples of the same material type.

One particularly advantageous alternative example of the apparatus is the use of the multiple receiver array as the common transmitting means for the present invention. In this example, for transmission, the array coils are coupled in series or in parallel and appropriate tuning is provided using a switch so as to transmit uniformly to all of the samples. Following transmission the array is switched to provide receiving using the coils individually. Such switching is provided under the control of the processor 30.

Although the above example has primarily been described in connection with biochemical materials containing solutions, it will be appreciated that any material capable of exhibiting nuclear magnetic resonance may be used in accordance with the invention. The invention is also therefore not limited to any particular magnetic field strengths. Whilst 400 MHz magnets can be used for samples containing small molecules, more complex molecules may require higher fields (such as provided by 600, 700 and even 900 MHz magnets).

There are numerous applications in which the invention is beneficial. For example the apparatus may be used to provide a simultaneous “control” experiment to produce data for comparison with one or more samples of interest. There are also great advantages in chemical library screening such as in the pharmaceutical industry for use in structure determination where a large number of chemicals are often required to be analysed. Similar advantages are provided in the field of combinatorial chemistry.

1. Apparatus for causing nuclear magnetic resonance in a plurality of samples, the apparatus comprising:—
a magnet system for generating a magnetic field;
a sample holder adapted in use to hold the plurality of samples within a working volume in which the magnetic field is substantially homogeneous;
a common transmitting means for transmitting radio frequency signals simultaneously to each of the samples in the magnetic field so as to cause nuclear magnetic resonance within them; and
a multiple receiver array comprising a plurality of receiving circuits each comprising receiving means and each circuit having a different spatial sensitivity to each sample.

2. Apparatus according to claim 1, further comprising a processor for monitoring signals generated within the receiving circuits.

3. Apparatus according to claim 2, wherein the processor is adapted to monitor signals from a plurality of the samples simultaneously.

4. Apparatus according to claim 2 or claim 3, wherein the processor is arranged in use to process the monitored signals so as to distinguish between signals obtained from the respective samples.

5. Apparatus according to any of the preceding claims, wherein the magnet system is arranged in use to generate a magnetic field having a pulsed field gradient and wherein the plurality of samples are positioned within the magnetic field such that they each experience a substantially similar magnetic field gradient.

6. Apparatus according to any of the preceding claims, wherein the multiple receiver array is the common transmitting means.

7. Apparatus according to claim 6, wherein the multiple receiver array is switchable between common transmitting and receiving functions, and wherein each receiving means of the multiple receiver array are arranged to be connected in series or in parallel when acting as the common transmitting means.

8. Apparatus according to any of the preceding claims, wherein the receiving means comprises receiving coils.

9. Apparatus according to claim 8, wherein the receiving coils comprise at least one of saddle coils, birdcage coils or transverse electrometric resonators (TEMs).

10. Apparatus according to claim 9, wherein the receiving coils are arranged respectively so as to reduce or cancel their mutual inductance.

11. Apparatus according to claim 10, wherein when the coils are saddle coils pairs, the saddle coils are arranged to at least partially overlap along a particular dimension and wherein their relative spacing is arranged in relation to the samples within the holder such that each sample is positioned between a pair of saddle coils and is aligned substantially at the centre of a saddle coil pair with respect to the said dimension.

12. Apparatus according to any of the preceding claims, wherein the samples are arranged along an axis parallel to the magnetic field or magnetic field gradient.

13. Apparatus according to any of claims 1 to 10, wherein the receiving means are positioned azimuthally about a common axis.

14. Apparatus according to claim 13, wherein each receiving means is a transverse electrometric resonator (TEM), and wherein the magnet system has a cylindrical bore, the TEMs each being arranged to be curved in cross section so as to conform with the cylindrical bore of the magnet system.

15. Apparatus according to claim 13 or claim 14, further comprising a plurality of sample containers positioned azimuthally about a respective common axis.

16. Apparatus according to claim 15, wherein the common axis of the receiving circuits and the sample containers is substantially the same axis.

17. A probe for use with apparatus according to any of claims 1 to 16, in which nuclear magnetic resonance is generated in a plurality of samples, wherein the nuclear magnetic resonance apparatus comprises:—
a magnet system for generating a magnetic field;
a sample holder adapted in use to hold a plurality of samples within a working volume in which the magnetic field is substantially homogeneous;
a transmitting means for transmitting radio frequency signals to the samples in the magnetic field so as to cause nuclear magnetic resonance within them; and
a multiple receiver array comprising a plurality of receiving circuits, each comprising receiving means and each circuit having a different spatial sensitivity to each sample;
and wherein the multiple receiver array is mounted to the probe.

18. A probe according to claim 17, wherein the probe is arranged to be removably insertable into a bore of the magnet system.

19. A probe according to claim 17 or claim 18, wherein the probe is adapted to be cooled to cryogenic temperatures when in use.

20. A sample holder for use with apparatus according to any of claims 1 to 16, in which nuclear magnetic resonance is generated in a plurality of samples, wherein the nuclear magnetic resonance apparatus comprises:—
a magnet system for generating a magnetic field;
a transmitting means for transmitting radio frequency signals to the samples held in the magnetic field so as to cause nuclear magnetic resonance within them; and,
a multiple receiver array comprising a plurality of receiving circuits, each comprising receiving means and each circuit having a different spatial sensitivity to each sample;
and wherein the sample holder is adapted in use to hold the plurality of samples within a working volume in which the magnetic field is substantially homogenous.

21. A sample holder according to claim 20, wherein the sample holder is removably insertable into the nuclear magnetic resonance apparatus.

22. A sample holder according to claim 20 or claim 21, wherein the samples are spaced apart within the holder in accordance with the arrangement of the receiving means of the multiple receiver array.

23. A sample holder according to any of claims 20 to 22, wherein the samples are separated by a susceptibility matched material.

24. A sample holder according to any of claims 20 to 23, wherein the samples are substantially equally spaced.

25. A sample holder according to any of claims 20 to 24, wherein the samples are arranged upon a common axis.

26. A sample holder according to any of claims 20 to 25, wherein the sample holder comprises a number of removably stackable ampoules, each ampoule having a lid of susceptibility matched material and being formed as a container to retain an NMR sample in solution; and a tube within the ampoules are stacked when in use.

27. A sample holder according to claim 25 or claim 26, wherein the said lids comprise injection ports so as to allow the NMR samples in solution to be added or removed from the containers.

28. A sample holder according to any of claims 20 to 24, comprising a tube having an axis; and a number of sample containers azimuthally distributed within the tube, about the axis.

29. A sample holder according to any of claims 20 to 28, wherein the sample holder is adapted such that each sample is retained in solution within a quantity of liquid.

30. A sample holder according to claim 29, wherein each quantity of liquid has a volume between about 0.25 and 0.5 millilitres.

31. A sample holder according to claim 29, wherein each quantity of liquid has a volume between about 1 nanolitre and 10 microlitres.
